(19) United States
(12) Patent Application Publication
(10) Pub. No.: US 2008/0246470 A1
(43) Pub. Date: Oct. 9, 2008

(54) Magnetic Sensor Device With Field Compensation

(75) Inventors: Josephus Arnold Henricus Maria Kahlman, Tilburg (NL); Haris Duric, Helmond (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,934

(22) PCT Filed: Sep. 29, 2006
(86) PCT No.: PCT/IB2006/053559

§ 371 Date: Apr. 11, 2008

(30) Foreign Application Priority Data
Oct. 12, 2005 (EP) 05109457.1

(51) Int. Cl. G01N 15/06

(52) U.S. Cl. 324/234

(57) ABSTRACT

The invention relates to a magnetic sensor device (10) comprising an excitation wire (11) for the generation of a first magnetic field (B₁), a GMR sensor (12) for sensing stray fields (B′) generated by magnetized beads (2), and a compensation wire (13) for the generation of a second magnetic field (B2) that compensates the first magnetic field (B₁) in the GMR sensor (12). Preferably, the excitation and compensation wires (11, 13) are disposed symmetrically above and below the GMR sensor (12) and supplied with parallel currents (I₁, I₂) of equal magnitude. In a second mode of operation, the magnetic fields (B₁, B₂) can be set such that the substantially compensate in the region containing the beads (2), allowing to calibrate the GMR sensor (12).

The invention relates to a magnetic sensor device comprising at least one magnetic field generator and at least one associated magnetic sensor element. Moreover, it comprises the use of such a magnetic sensor device and a method for the detection of at least one magnetic particle in an investigation region.

From the WO 2005/010543 A1 and WO 2005/010542 A2 a microsensor device is known which may for example be used in a microfluidic biosensor for the detection of biological molecules labeled with magnetic beads. The microsensor device is provided with an array of sensors comprising wires for the generation of a magnetic field and Giant Magneto Resistances (GMRs) for the detection of stray fields generated by magnetized beads. The signal of the GMRs is then indicative of the number of the beads near the sensor. A problem of the known magnetic sensor devices is that the GMR is subjected to the relatively strong magnetic excitation field, which may lead to a corruption of the desired signal.

Based on this situation it was an object of the present invention to provide means that allow a more accurate measurement with a magnetic sensor device of the aforementioned kind.

This object is achieved by a magnetic sensor device according to claim 1, a method according to claim 10, and a use according to claim 13. Preferred embodiments are disclosed in the dependent claims.

The magnetic sensor device according to the present invention comprises the following components:
a) At least one magnetic field generator for generating a first magnetic field in an investigation region. The magnetic field generator may for example be realized by a wire (“excitation wire”) on a substrate of a microsensor.
b) At least one magnetic sensor element having a sensitive direction and being associated with the aforementioned magnetic field generator in the sense that it is in the reach of effects caused by the magnetic field of the magnetic field generator. The magnetic sensor element may particularly be a magneto-resistive element of the kind described in the WO 2005/010543 A1 or WO 2005/010542 A2. The “sensitive direction” of the magnetic sensor element means that the sensor element is most (or only) sensitive with respect to components of a magnetic field vector that are parallel to said spatial direction. Usually, the magnetic sensor element has only one sensitive direction and is substantially insensitive to components of a magnetic field perpendicular to this direction.
c) At least one magnetic field compensator for generating a second magnetic field. The magnetic field compensator may for example be realized by a wire (“compensation wire”) on a substrate of a microsensor.
d) A controller coupled to the magnetic field generator and the magnetic field compensator for controlling the generation of the first and the second magnetic field. The controller may for example be a circuit that controls the magnitude and direction of currents flowing through wires that constitute the magnetic field generator and magnetic field compensator.

The magnetic sensor device is designed in such a way that it allows an operation during which the first and the second magnetic field substantially compensate each other in the magnetic sensor element and with respect to the sensitive direction of the magnetic sensor element.

The described magnetic sensor device has the advantage that the direct influence of the first magnetic field generated by the magnetic field generator can be cancelled by compensating it effectively with the second magnetic field. Signals generated by the magnetic sensor element are therefore only due to the effect one is interested in, for example the stray fields of magnetic particles in the investigation region. Signal corruption due to crosstalk from the magnetic field generator can thus be minimized.

The condition that the first and the second magnetic fields substantially compensate in the sensitive direction of the magnetic sensor element can primarily be achieved by an appropriate arrangement and design of the magnetic field generator and the magnetic field compensator together with appropriate operating conditions determined by the controller. According to a first embodiment of the magnetic sensor device, the magnetic field generator and the magnetic field compensator are arranged symmetrically with respect to the sensitive direction of the magnetic sensor element, wherein the sensitive direction is understood to be a line or plane running through the magnetic sensor element (or, more precisely, the sensitive region thereof). Moreover, the magnetic field generator and the magnetic field compensator are preferably of the same design, for example wires of the same material and with the same geometry. Such a symmetrical layout of the magnetic field generator and the magnetic field compensator guarantees that the magnetic fields generated by them can exactly compensate in the central plane of the arrangement. If there are deviations from said symmetrical layout, they may be compensated during the operation of the magnetic sensor device by changing the balance between the wire currents.

As was already mentioned, the magnetic field generator and/or the magnetic field compensator may especially comprise at least one conductor wire. The magnetic sensor element may particularly be realized by a magneto-resistive element, for example a Giant Magnetic Resistance (GMR), a TMR (Tunnel Magneto Resistance), or an AMR (Anisotropic Magneto Resistance). Moreover, the magnetic sensor element can be any suitable sensor element based on the detection of the magnetic properties of particles to be measured on or near to the sensor surface. Therefore, the magnetic sensor element is designable as a coil, magneto-resistive sensor, magneto-restrictive sensor, Hall sensor, planar Hall sensor, flux gate sensor, SQUID (Semiconductor Superconducting Quantum Interference Device), magnetic resonance sensor, or as another sensor actuated by a magnetic field. Moreover, the magnetic field generator, the magnetic field compensator, and the magnetic sensor element may be realized as an integrated circuit, for example using CMOS technology together with additional steps for realizing the magneto-resistive components on top of a CMOS circuitry. Said integrated circuit may optionally also comprise the controller of the magnetic sensor device.

According to another preferred embodiment of the magnetic sensor device, the magnetic sensor element is disposed in the middle between a number N (e.g. N=2) of magnetic field generators and the same number N of magnetic field compensators, wherein the configuration (i.e. the spatial distribution) of the magnetic field generators is the same as the configuration of the magnetic field compensators. Thus a symmetrical arrangement of the generators and magnetic fields with respect to the magnetic sensor element is achieved.

According to another development of the magnetic sensor device, the controller is adapted to control the first and the second magnetic field in a second operation mode in such a way that they substantially compensate in the investigation region. Thus a condition can be established in which no magnetic signals (for example stray fields of magnetized particles) are stimulated in the investigation region and in which definite magnetic conditions prevail in the magnetic sensor element.

In a further development of the aforementioned embodiment, the controller is adapted to calibrate the magnetic sensor element (including the associated processing circuitry) based on the second operation mode, i.e. the condition that the first and the second magnetic field substantially compensate in the investigation region. Such a calibration with definite conditions in the magnetic sensor element allows to improve the accuracy of the device substantially.

According to another embodiment of the invention, the magnetic sensor device comprises one energy supply, e.g. a current source, which feeds both the magnetic field generator and the magnetic field compensator. The use of only one energy supply instead of two separate ones has the advantage that an addition of two independent noise contributions (from two independent energy supplies) can be avoided.

The invention further relates to a method for the detection of at least one magnetic particle in an investigation region, for example of a magnetic bead immobilized on a sensor surface, the method comprising the following steps:
a) Generating a first magnetic field in the investigation region.
b) Generating a second magnetic field such that it substantially compensates the first magnetic field in the sensitive direction of a magnetic sensor element.
c) Sensing a magnetic property of the particle with the magnetic sensor element.

The method comprises in general form the steps that can be executed with a magnetic sensor device of the kind described above. Therefore, reference is made to the preceding description for more information on the details, advantages and improvements of that method.

According to a preferred embodiment of the method, the first and second magnetic fields are generated by parallel currents of equal magnitude. In this case the magnetic fields associated with the currents exactly cancel in the central symmetry plane of the currents. Preferably the wires are connected in series to guarantee that the currents are perfectly equal and that a very (temperature-) stable magnetic compensation is achieved. Moreover, a connection in series implies that only one current source (and thus a minimal noise input) is involved. Furthermore, the wires may be arranged parallel to each other with the direction of current flow being parallel or anti-parallel.

Optionally the method comprises the further steps of changing the magnetic fields such that they substantially compensate in the investigation region, and calibrating the magnetic sensor element during such a condition. The cancellation of the magnetic fields in the investigation region avoids a stimulation of magnetic signals from particles in the investigation region and thus allows a calibration of the electronics under well defined magnetic conditions in the magnetic sensor element.

The invention further relates to the use of the magnetic sensor device described above for molecular diagnostics, biological sample analysis, or chemical sample analysis. Molecular diagnostics may for example be accomplished with the help of magnetic beads that are directly or indirectly attached to target molecules.

These and other aspects of the invention will be apparent from and elucidated with reference to the embodiment(s) described hereinafter. These embodiments will be described by way of example with the help of the accompanying drawings in which:

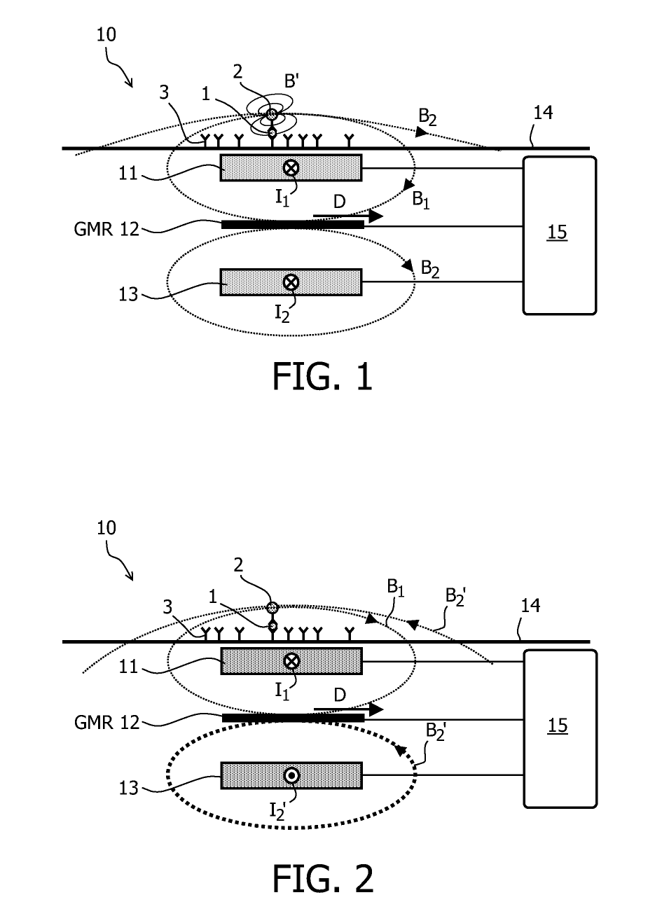

FIG. 1 shows schematically a magnetic sensor device according to a first embodiment of the present invention during a first operation mode (measurement);

FIG. 2 shows the magnetic sensor device of FIG. 1 during a second operation mode (calibration);

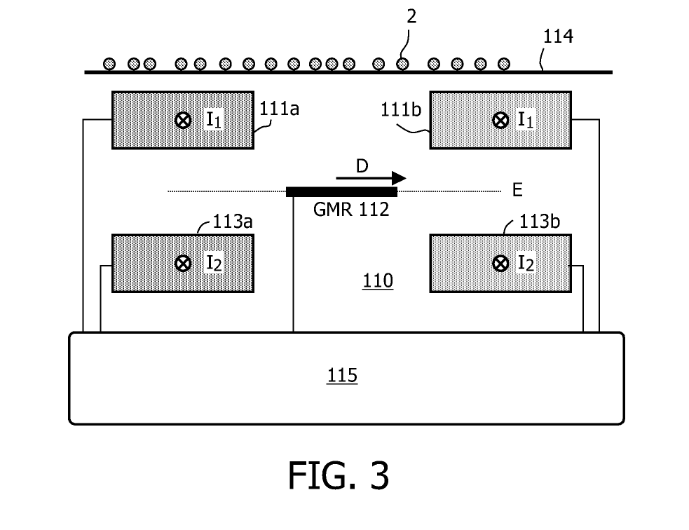

FIG. 3 shows schematically a magnetic sensor device according to a second embodiment of the invention.

Like reference numbers in the Figures refer to identical or similar components.

Magneto-resistive biochips or biosensors have promising properties for bio-molecular diagnostics, in terms of sensitivity, specificity, integration, ease of use, and costs. Examples of such biochips are described in the WO 2003/054566, WO 2003/054523, WO 2005/010542 A2, WO 2005/010543 A1, and WO 2005/038911 A1, which are incorporated into the present application by reference.

FIG. 1 illustrates a first embodiment of a single magnetic sensor device 10 according to the present invention for the detection of superparamagnetic beads 2. A biosensor consisting of an array of (e.g. 100) such sensor devices 10 may be used to simultaneously measure the concentration of a large number of different biological or synthesized target molecules 1 (e.g. protein, DNA, amino acids, drugs) in a solution (e.g. blood or saliva). In one possible example of a binding scheme, the so-called “sandwich assay”, this is achieved by providing a binding surface 14 with first antibodies 3, to which the target molecules 1 may bind. Superparamagnetic beads 2 carrying second antibodies may then attach to the bound target molecules 1. A current flowing in an excitation wire 11 acting as a “magnetic field generator” generates a magnetic field B₁, which then (together with a field B₂ from a wire 13, to be explained below) magnetizes the superparamagnetic beads 2. The stray field B′ from the super-paramagnetic beads 2 introduces a magnetization component in the Giant Magneto Resistance (GMR) 12 of the sensor device 10 that lies in the sensitive direction D of the GMR 12 and therefore generates a measurable resistance change. This method is also applicable to other binding schemes (e.g. inhibition or competitive assays) to detect small molecules like drugs. Furthermore this method may also be used to detect (immobilized) magnetic beads at a certain distance from the sensor surface (bulk measurement).

In order to realize a sensitive, fast and stable sensor, it is proposed here to apply magnetic fields that compensate within the GMR sensor 12. In particular, the magnetic fields may be symmetrical with respect to the sensitive direction D of the GMR sensor 12.

FIG. 1 shows a particular realization of this general concept. The magnetic sensor device 10 comprises a second, “compensation” wire 13 that acts as a “magnetic field compensator” and that is arranged like the mirror image of the excitation wire 11 with respect to the sensitive direction D of the GMR sensor 12. With other words, the excitation wire 11 and the compensation wire 13 have the same dimensions and geometry, and the GMR sensor 12 is arranged in the middle between them.

FIG. 1 further schematically depicts a controller 15 that is coupled to both the excitation wire 11 and the compensation wire 13 and that may be integrated into the same microchip. The controller 15 can supply in a first operation mode both wires 11, 13 with parallel currents I₁, I₂ of the same magnitude. These currents will therefore generate magnetic fields B₁, B₂ of the same spatial shape and size but with different origins in the wires 11 and 13, respectively. In the symmetry plane of the magnetic fields B₁, B₂, both fields will therefore exactly cancel. Thus the first magnetic field B₁ is compensated by the second magnetic field B₂ within the GMR sensor 12. The currents I₁, I₂ are preferably generated by the same current source to minimize noise input.

FIG. 2 shows the magnetic sensor device 10 of FIG. 1 in a second mode of operation. In contrast to FIG. 1, the second current 12′ in the compensation wire 13 is now anti-parallel to the first current I₁ in the excitation wire 11. Moreover, the second current I₂′ is so much larger than the first current I₁ that the magnetic fields B₁, B₂′ generated by the currents I₁ and I₂′, respectively, will substantially cancel within the investigation region above the binding surface 14. Therefore, no stray fields are generated by the magnetic particles 2, and the GMR sensor 12 experiences exclusively the sum of the two magnetic fields B₁ and B₂′ (which now do not cancel within the GMR sensor 12). As the magnitude of this superposition of magnetic fields in the GMR sensor 12 is known and well defined, it can be used by the controller 15 to calibrate the gain of the GMR sensor 12 and the associated processing electronics.

By applying anti-parallel currents to the excitation wire 11 on the one hand side and to the compensation wire 13 on the other hand side, the magnetic field is concentrated between said current wires and used to calibrate the sensor- and detection electronics gain, without magnetizing the beads. Said calibration may be time-multiplexed with the actual bio-measurement by applying alternating parallel- and anti-parallel currents to the wires. Moreover, frequency multiplex by using different frequencies for the parallel and anti-parallel currents is also possible to implement continuous measurement and calibration in order to achieve a more accurate signal. In this case, measurement signals and calibration signals have to be separated in the frequency domain.

It should be noted that in the present text a “measurement” refers to the signals obtained from the GMR sensor 12 in a configuration like that of FIG. 1. A further processing of these “measurements” will then inter alia take the calibration results into account to determine corrected (or “calibrated”) data which more accurately represent the values one is interested in.

FIG. 3 shows an alternative embodiment of a magnetic sensor device 110, wherein the same components as in FIG. 1 and 2 have the same reference numbers increased by 100. The magnetic sensor device 110 comprises a pair of excitation wires 111a, 111b and a pair of compensation wires 113a, 113b. These pairs are arranged symmetrically with respect to a symmetry plane E that comprises the GMR sensor 112 with its sensitive direction D. By applying currents of the same magnitude and direction to the wires, an exact compensation of the generated magnetic fields can therefore be achieved in the GMR sensor 112. Moreover, anti-parallel currents (not shown) can again be used for calibration purposes.

In all embodiment disclosed above, currents through the excitation wires and the compensation wires (whether being equal in magnitude or not) are preferably generated by the same current source to minimize noise contributions.

The described magnetic sensor devices 10, 110 fulfill the following requirements:
1. Large magnetic coupling between magnetic beads 2 and GMR sensor 12, 112. Beads on the surface are magnetized in the x-direction, which couples optimal into the sensitive layer of the GMR sensor. This improves the signal-to-noise ratio of the measurement.
2. Low magnetic coupling between field generating wires 11, 13, 111a, 111b, 113a, 113b and magneto resistive sensor 12, 112 (low magnetic crosstalk) that minimizes the effect of gain variations and Barkhausen noise.

In a symmetrical geometry and with equal currents in the same direction applied to the field generating current wires, the magnetic field in the sensitive layer may be zero. Preferably the sensitive layer of the GMR sensor is located halfway the two field generating wires.
3. Magnetic attraction of the magnetic beads towards the most sensitive area of the sensor.
4. Magnetic shielding of the GMR sensor 12, 112 by adding anti-parallel compensation currents, which generate a compensation field in the GMR and do not magnetize the beads. The shielding allows the use of external actuation fields by preventing shifting of the magnetic operating point and saturation of the sensor.
5. Possibility of gain calibration of sensor and signal processing electronics by applying currents in opposite direction.
6. High fill factor due to the compact design. Low antibody consumption per sensor.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A magnetic sensor device (10, 110), comprising
a) at least one magnetic field generator (11, 111a, 111b) for generating a first magnetic field (B₁) in an investigation region;
b) at least one associated magnetic sensor element (12, 112) having a sensitive direction (D);
c) at least one magnetic field compensator (13, 113a, 113b) for generating a second magnetic field (B₂);
d) a controller (15, 115) coupled to the magnetic field generator (11, 111a, 111b) and the magnetic field compensator (13, 113a, 113b) for controlling the generation of the first and the second magnetic field (B₁, B₂);
wherein the magnetic sensor device (10, 110) is designed in such a way that it allows an operation mode in which the first and second magnetic fields (B₁, B₂) substantially compensate in the magnetic sensor element (12, 112) with respect to the sensitive direction (D) thereof.

2. The magnetic sensor device (10, 110) according to claim 1, characterized in that the magnetic field generator (11, 111a, 111b) and the magnetic field compensator (13, 113a, 113b) are arranged symmetrically with respect to the sensitive direction (D) of the magnetic sensor element (12, 112).

3. The magnetic sensor device (10, 110) according to claim 1,
characterized in that the magnetic field generator (11, 111a, 111b) and/or the magnetic field compensator (13, 113a, 113b) comprise conductor wires.

4. The magnetic sensor device according to claim 1,
characterized in that the magnetic sensor element (12, 112) is a magneto-resistive element, preferably a Giant Magnetic Resistance, or Tunnel Magneto Resistance or Anisotropic Magneto Resistance, and/or a Hall sensor.

5. The magnetic sensor device (10, 110) according to claim 1,
characterized in that the magnetic sensor element (12, 112) is disposed in the middle between a number of magnetic field generators (11, 111a, 111b) and the same number of magnetic field compensators (13, 113a, 113b), wherein the configuration of the magnetic field generators (11, 111a, 111b) is the same as the configuration of the magnetic field compensators (13, 113a, 113b).

6. The magnetic sensor device (10, 110) according to claim 1,
characterized in that it is realized as an integrated circuit.

7. The magnetic sensor device (10, 110) according to claim 1,
characterized in that the controller (15, 115) is adapted to control the first and the second magnetic field (B₁, B₂) in a second operation mode such that they substantially compensate in the investigation region.

8. The magnetic sensor device (10, 110) according to claim 7,
characterized in that the controller (15, 115) is adapted to calibrate the magnetic sensor element (12, 112) based on the second operation mode.

9. The magnetic sensor device (10, 110) according to claim 1,
characterized in that it comprises an energy supply which feeds both the magnetic field generator (11, 111a, 111b) and the magnetic field compensator (13, 113a, 113b).

10. A method for the detection of at least one magnetic particle (2) in an investigation region, the method comprising the following steps:
a) generating a first magnetic field (B₁) in the investigation region;
b) generating a second magnetic field (B₂) such that it substantially compensates the first magnetic field (B₁) in the sensitive direction (D) of magnetic sensor element (12, 112);
c) sensing a magnetic property of the particle (2) with the magnetic sensor element (12, 112).

11. The method according to claim 10,
characterized in that the first and the second magnetic fields (B₁, B₂) are generated by parallel currents (I₁, I₂) of equal magnitude.

12. The method according to claim 10, characterized in that it further comprises the following step:
d) changing the magnetic fields (B₁, B₂) such that they substantially compensate in the investigation region, and calibrating the magnetic sensor element (12, 112) based on such a condition.

13. Use of the magnetic sensor device (10) according to claim 1 for molecular diagnostics, biological sample analysis, or chemical sample analysis.
